(19) United States
(12) Patent Application Publication
(10) Pub. No.: US 2026/0141241 A1
(43) Pub. Date: May 21, 2026

(54) DEVICE AND METHOD FOR PRUNING MODEL

(71) Applicant: Industrial Technology Research Institute, Hsinchu (TW)

(72) Inventors: Xuan-Wei Wu, Taichung City (TW); Chih-Chi Wu, Hsinchu County (TW)

(73) Assignee: Industrial Technology Research Institute, Hsinchu (TW)

(21) Appl. No.: 19/060,773

(22) Filed: Feb. 23, 2025

(30) Foreign Application Priority Data
Nov. 18, 2024 (TW) 113144239

(51) Int. Cl. G06N 3/082; G06N 3/0495

(52) U.S. Cl. CPC G06N 3/082; G06N 3/0495

(57) ABSTRACT

Provided are a device and a method for pruning a model. The method includes the following steps: inputting, by a layer outlier obtaining module, a calibration data set into the model to obtain a layer outlier corresponding to each of a plurality of layers, in which the model includes the plurality of layers; using, by a candidate layer selection module, the layer outlier to select a candidate layer from the plurality of layers; pruning, by a layer pruning module, the candidate layer from the model to obtain a pruned model; using, by a layer fusion module, the candidate layer and the pruned model to obtain a fused model; and determining, by a compression specification module, whether the model meets a compression specification.

### CROSS-REFERENCE TO RELATED APPLICATION

This application claims the priority benefit of Taiwan application serial no. 113144239, filed on Nov. 18, 2024. The entirety of the above-mentioned patent application is hereby incorporated by reference herein and made a part of this specification.

### TECHNICAL FIELD

The disclosure relates to a device and a method for pruning a model.

### BACKGROUND

In the field of artificial intelligence, models may have redundant layers. Moreover, the size of existing models may not necessarily meet the specification requirements for actual inference and training.

### SUMMARY

A device and a method for pruning a model are introduced herein, which can effectively reduce the size of the model and avoid the performance loss of the model.

The device for pruning the model of the disclosure includes a storage medium and a processor. The storage medium stores a plurality of modules. The processor is coupled to the storage medium and accesses and executes the plurality of modules, in which the plurality of modules include a layer outlier obtaining module, a candidate layer selection module, a layer pruning module, a layer fusion module, and a compression specification module. The layer outlier obtaining module inputs a calibration data set into the model to obtain a layer outlier corresponding to each of a plurality of layers, in which the model includes the plurality of layers; the candidate layer selection module uses the layer outlier to select a candidate layer from the plurality of layers; the layer pruning module prunes the candidate layer from the model to obtain a pruned model; the layer fusion module uses the candidate layer and the pruned model to obtain a fused model; and the compression specification module determines whether the model meets a compression specification.

The method for pruning the model of the disclosure is suitable for a device including a storage medium and a processor, in which the storage medium stores a plurality of modules, the processor is coupled to the storage medium and accesses and executes the plurality of modules, and the plurality of modules include a layer outlier obtaining module, a candidate layer selection module, a layer pruning module, a layer fusion module, and a compression specification module, in which the method includes the following steps: inputting, by the layer outlier obtaining module, a calibration data set into the model to obtain a layer outlier corresponding to each of a plurality of layers, in which the model includes the plurality of layers; using, by the candidate layer selection module, the layer outlier to select a candidate layer from the plurality of layers; pruning, by the layer pruning module, the candidate layer from the model to obtain a pruned model; using, by the layer fusion module, the candidate layer and the pruned model to obtain a fused model; and determining, by the compression specification module, whether the model meets a compression specification.

Based on the above, the device and the method for pruning the model of the disclosure can obtain the layer outlier of each layer in the model, use the layer outlier to select the candidate layer, and prune the candidate layer from the model. In particular, the disclosure can re-fuse the pruned layer back into the model. Based on the above, the disclosure can effectively reduce the size of the model while retaining more of the original capabilities of the model to avoid performance loss of the model. The disclosure can meet the demand for high-efficiency operation in a resource-limited environment, and the disclosure can be used in large language models.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram of a device for pruning a model according to an embodiment of the disclosure.

FIG. 2 is a flowchart of a method for pruning a model according to an embodiment of the disclosure.

FIG. 3 is an implementation example of Step S21 to Step S23 shown in FIG. 2.

FIG. 4A, FIG. 4B, and FIG. 4C are implementation examples of Step S24 shown in FIG. 2.

FIG. 5 is a flowchart of the method for pruning the model according to another embodiment of the disclosure.

### DETAILED DESCRIPTION OF DISCLOSED EMBODIMENTS

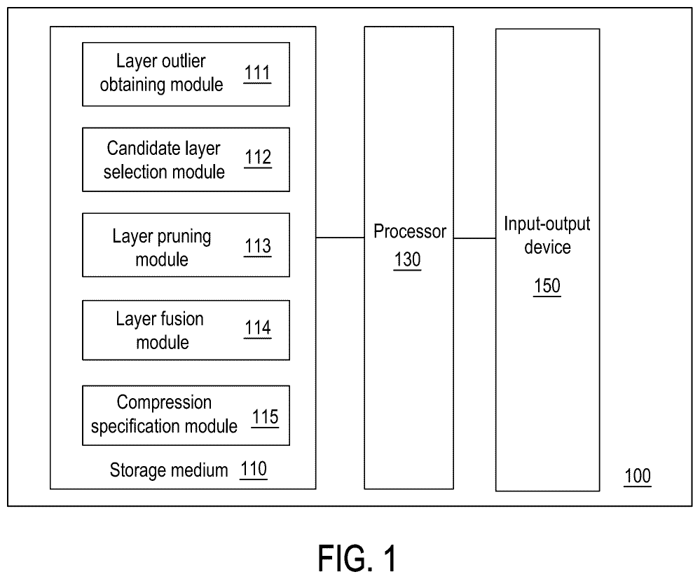

FIG. 1 is a schematic diagram of a device 100 for pruning a model according to an embodiment of the disclosure. Referring to FIG. 1, a device 100 may include a storage medium 110 and a processor 130. The storage medium 110 may store a plurality of modules. The processor 130 may be coupled to the storage medium 110 and access and execute the plurality of modules, in which the plurality of modules may include a layer outlier obtaining module 111, a candidate layer selection module 112, a layer pruning module 113, a layer fusion module 114, and a compression specification module 115. In an embodiment, the device 100 may include an input-output device 150 coupled to the processor 130.

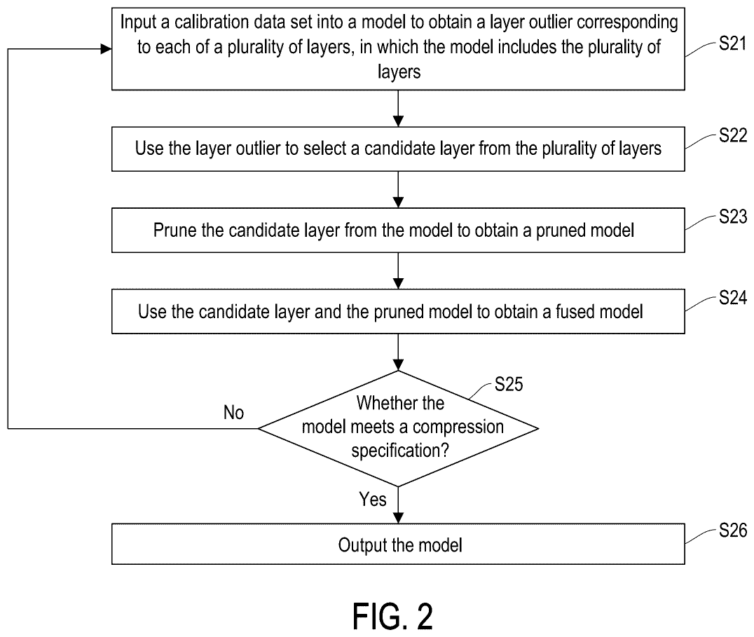

FIG. 2 is a flowchart of a method for pruning a model according to an embodiment of the disclosure, in which the method may be implemented by the device 100 shown in FIG. 1. Please refer to FIG. 1 together with FIG. 2.

In Step S21, the layer outlier obtaining module 111 may input the calibration data set into the model to obtain the layer outlier corresponding to each of the plurality of layers, in which the model may include the plurality of layers. In an embodiment, the layer outlier obtaining module 111 may receive the model and the calibration data set through the input-output device 150. In other words, the user may input the model and the calibration data set into the device 100.

In Step S22, the candidate layer selection module 112 may use the layer outlier to select the candidate layer from the plurality of layers.

In Step S23, the layer pruning module 113 may prune the candidate layer from the model to obtain a pruned model.

In Step S24, the layer fusion module 114 may use the candidate layer and the pruned model to obtain a fused model.

In Step S25, the compression specification module 115 may determine whether the model meets the compression specification. In other words, the compression specification module 115 may determine whether the pruned and fused model meets the compression specification. In an embodiment, the compression specification module 115 may receive the compression specification through the input-output device 150. In other words, the user may input the compression specification into the device 100.

If the compression specification module 115 determines that the model does not meet the compression specification (the determination result of Step S25 is “no”), then Step S21 may be re-executed. On the other hand, if the compression specification module 115 determines that the model meets the compression specification (the determination result of Step S25 is “yes”), then in Step S26, the compression specification module 115 may output the model through the input-output device 150.

Step S21 in FIG. 2 will be further described below with an embodiment.

In an embodiment, each of the plurality of layers may include a matrix. The layer outlier obtaining module 111 may use the absolute value of the matrix and the normalized calibration data set to obtain a target matrix corresponding to the matrix. Then, the layer outlier obtaining module 111 may obtain an outlier rate corresponding to the target matrix. Then, the layer outlier obtaining module 111 may use the outlier rate to obtain the layer outlier. Furthermore, in an embodiment, the target matrix may include elements. The layer outlier obtaining module 111 may use the quantity of the elements, the mean of the elements, and the standard deviation of the elements to obtain the outlier rate.

For example, it is assumed that the calibration data set is X. Furthermore, it is assumed that the model includes 40 layers, and each layer includes 7 matrices including a query matrix, a key matrix, a value matrix, an attention output matrix, an upper matrix, a lower matrix, and a gate matrix. For an attention output matrix

$$W = = [ \begin{matrix}4 & 0 & 1 & - 1 \\ 3 & - 2 & - 1 & - 3 \\ - 3 & 1 & 0 & 2\end{matrix} ]$$

in a specific layer L, the layer outlier obtaining module 111 may use the absolute value of the matrix W and a normalized calibration data set Norm (X)=[1 2 8 3] to obtain a target matrix

$$S = [ \begin{matrix}4 & 0 & 8 & 3 \\ 3 & 4 & 8 & 9 \\ 3 & 2 & 0 & 6\end{matrix} ]$$

corresponding to the attention output matrix W. In detail, the layer outlier obtaining module 111 may successively multiply “the row vector of the absolute value of the attention output matrix W” and “the element of the Norm (X)” to obtain the target matrix S. Then, the layer outlier obtaining module 111 may obtain the outlier rate corresponding to the target matrix S. For example, the layer outlier obtaining module 111 may first use the following Formula 1 to obtain the standard deviation corresponding to each element in the target matrix S.

$$\sqrt{\frac{1}{n - 1} {\sum }_{i = 1}^{n} {( {X}_{i} - \overline{X} )}^{2}} \qquad ( Formula 1 )$$

In the formula, the quantity of the elements in the target matrix S is n, the elements in the target matrix S are X₁ to Xₙ, and X̅ is the mean of each element in the target matrix S.

The mean X̅ of the 12 elements of the target matrix S is approximately 4.17. The layer outlier obtaining module 111 may use Formula 1 to calculate the standard deviation of the 12 elements in the target matrix S to be approximately 3.01. Then, the layer outlier obtaining module 111 may add m times the standard deviation to the mean X̅. Assuming that m is 1, that is, the operation is 4.17+m×3.01=7.18. Since the quantity of the elements greater than 7.18 in the target matrix

$$S = [ \begin{matrix}4 & 0 & 8 & 3 \\ 3 & 4 & 8 & 9 \\ 3 & 2 & 0 & 6\end{matrix} ]$$

is 3, the outlier rate of the target matrix S obtained by the layer outlier obtaining module 111 is 3/12, which is 25%. In other words, the outlier rate of the attention output matrix of the layer L is 25%. It should be noted here that the operation of “adding m times the standard deviation to the mean X̅” is merely an implementation example of the disclosure. In other embodiments, the layer outlier obtaining module 111 may use a box plot or DBSCAN (density-based spatial clustering of applications with noise) to obtain the outlier rate of the target matrix S, but the disclosure is not limited thereto.

Then, the layer outlier obtaining module 111 may use the outlier rate of the target matrix to obtain the layer outlier of the layer L. Assuming that the layer outlier obtaining module 111 calculates in the above manner that the outlier rate of the query matrix of the layer L is 30%, the outlier rate of the key matrix is 10%, the outlier rate of the value matrix is 20%, the outlier rate of the attention output matrix is 25%, the outlier rate of the upper matrix is 13%, the outlier rate of the lower matrix is 3%, and the outlier rate of the gate matrix is 1%, and the layer outlier obtaining module 111 may use the average value (14.57%) of these outlier rates as the layer outlier of the layer L.

It should be noted here that the above is merely an implementation example of Step S21 in FIG. 2. In another embodiment, the layer outlier obtaining module 111 may calculate the layer outlier according to the changes in the input and output of each layer. In detail, the output of a specific layer is the result of the operation of the input of the layer and the parameters of the layer. The layer outlier obtaining module 111 may use similarity or distance formulas such as cosine similarity, Euclidean distance, or Manhattan distance to measure the changes in the input and output, but the disclosure is not limited thereto. In more detail, when the layer outlier obtaining module 111 uses the distance formula, the farther the distance between the input and the output, the higher the importance of the layer. On the other hand, when the layer outlier obtaining module 111 uses the similarity formula, the higher the similarity between the input and the output, the less important the layer is. Therefore, contrary to the distance formula, the layer outlier obtaining module 111 may subtract the similarity from 1 and use the result as the layer outlier. For example, it is assumed that calibration data in the calibration data set includes 128 samples with a length of 1024 tokens. The input of each layer has 128×1024 feature vectors, and the output obtained after the operation of the layer also has 128×1024 feature vectors. After the layer outlier obtaining module 111 performs a cosine operation on the corresponding vectors of the input and output, the layer outlier obtaining module 111 may obtain 128×1024 scalar values. Then, the layer outlier obtaining module 111 may take the average of the scalar values to obtain the average cosine score of the input and output of the layer. Finally, the score is subtracted from 1 to obtain the layer outlier of the layer.

In another embodiment, after the layer outlier obtaining module 111 calculates changes in the input and output of each layer, the layer outlier obtaining module 111 may perform a normalization operation. In detail, the normalization operation may include dividing by the norm of the input (Norm), dividing by the norm of the output, or dividing by both. The norm may be the L2 norm, but the disclosure is not limited thereto. For example, it is assumed that the calibration data in the calibration data set includes 128 samples with a length of 1024 tokens. The input of each layer has 128×1024 feature vectors, and the output obtained after the operation of the layer also has 128×1024 feature vectors. The layer outlier obtaining module 111 may subtract the corresponding vectors of the input and output to obtain 128×1024 feature vector differences. Then, the layer outlier obtaining module 111 may take the L2 norm for each feature vector difference to obtain 128×1024 scalar values. Then, the layer outlier obtaining module 111 may take the L2 norm for each output feature vector to obtain another 128×1024 scalar values. Then, the layer outlier obtaining module 111 may divide the scalar values corresponding to the former and the latter and take the average to obtain the layer outlier of the layer.

Step S22 to Step S25 in FIG. 2 will be further described below with embodiments. It is worth mentioning that the candidate layer selection module 112 may select the candidate layer in a manner of “small batches multiple times” so that the pruned model meets the compression specification. The compression specification will be further described below.

In an embodiment, the plurality of layers may include layers to be pruned, in which the compression specification may include the quantity of the layers to be pruned. In an embodiment, the quantity of the layers to be pruned is N. The candidate layer selection module 112 may set the quantity of the candidate layers to K, in which K is less than or equal to N. In an embodiment, K may be a factor of N, but the disclosure is not limited thereto. In other words, assuming that K is 1, the layer pruning module 113 merely prunes one layer from the model at a time, and Step S21 to Step S25 shown in FIG. 2 are repeatedly executed N times. On the other hand, assuming that K is equal to N, the layer pruning module 113 prunes N layers from the model at a time, and Step S21 to Step S25 shown in FIG. 2 are merely executed once.

In an embodiment, the compression specification may include an accuracy threshold. The compression specification module 115 may use a target evaluation data set to determine whether the pruned model meets the accuracy threshold. In other words, the user may input the target evaluation data set into the device 100 through the input-output device 150. The accuracy threshold is, for example, “97% of the accuracy of the unpruned model”. Alternatively, the accuracy threshold is, for example, “85%”, that is, the accuracy threshold may have nothing to do with the unpruned model. It is worth mentioning that Step S22 to Step S25 in FIG. 2 may be implemented sequentially based on (a) to (c) (the manner of “small batches multiple times”) as follows.
(a) The candidate layer selection module 112 may set the quantity K of the candidate layers. Then, the layer pruning module 113 prunes merely K layers from the model at a time. The value of K is, for example, 1.
(b) The compression specification module 115 may use the target evaluation data set to determine whether the model after pruning the K layers meets the accuracy threshold.
(c) If the compression specification module 115 determines that the model after pruning the K layers meets the accuracy threshold, then the operation returns to (a), and (a) to (c) are sequentially executed again. On the other hand, if the compression specification module 115 determines that the model after pruning the K layers does not meet the accuracy threshold, then the operation is no longer executed.

In other embodiments, the compression specification module 115 may output the model after pruning the K layers in (b) through the input-output device 150 for user confirmation.

In other embodiments, the compression specification module 115 may use the target evaluation data set to obtain the accuracy of the model after pruning the K layers in (b). Then, the compression specification module 115 may output the accuracy through the input-output device 150 for user confirmation.

In an embodiment, the compression specification may include an inference speed threshold. The inference speed threshold is, for example, “1.1 times the inference speed of the unpruned model.” Alternatively, the inference speed threshold is, for example, “45 ms”, that is, the inference speed threshold may have nothing to do with the unpruned model. The “inference speed” may be the “delay time” of model inference. It is worth mentioning that in this embodiment, Step S22 to Step S25 in FIG. 2 may be implemented sequentially based on a manner similar to (a) to (c) (the manner of “small batches multiple times”).

In an embodiment, the compression specification may include a hardware limitation threshold. The hardware limitation threshold is, for example, “97% of the memory usage of the unpruned model”. Alternatively, the hardware limitation threshold is, for example, “20000 MB”, that is, the hardware limitation threshold may have nothing to do with the unpruned model. It is worth mentioning that in this embodiment, Step S22 to Step S25 in FIG. 2 may be implemented sequentially based on a manner similar to (a) to (c) (the manner of “small batches multiple times”).

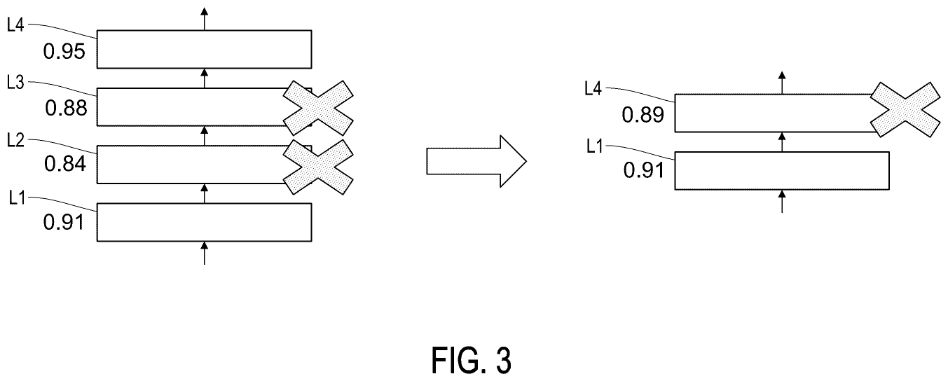

FIG. 3 is an implementation example of Step S21 to Step S23 shown in FIG. 2. Please refer to FIG. 1, FIG. 2, and FIG. 3 at the same time. In this embodiment, the candidate layer selection module 112 may use the layer outlier and a layer outlier threshold to select the candidate layer from the plurality of layers. In detail, the candidate layer selection module 112 may receive the layer outlier threshold through the input-output device 150. In other words, the user may input the layer outlier threshold into the device 100. It is assumed that the layer outlier threshold is 0.9. Furthermore, as shown in FIG. 3, it is assumed that the model includes four layers: a layer L1, a layer L2, a layer L3, and a layer L4, and assumed that the layer outlier of the layer L1 is 0.91, the layer outlier of the layer L2 is 0.84, the layer outlier of the layer L3 is 0.88, and the layer outlier of the layer L4 is 0.95. Since the layer outlier 0.84 of the layer L2 and the layer outlier 0.88 of the layer L3 are less than the layer outlier threshold 0.9, the candidate layer selection module 112 may select the candidate layers to be the layer L2 and the layer L3. In other words, at this time, the candidate layer selection module 112 may dynamically determine the quantity K of the candidate layers to be 2. Then, the layer pruning module 113 may prune the layer L2 and the layer L3 from the model to obtain the pruned model.

After pruning the layer L2 and the layer L3 from the model, the layer outlier obtaining module 111 may regain the layer outliers of the layer L1 and the layer LA. At this time, it is assumed that the layer outlier of the layer L1 is 0.91, and assumed that the layer outlier (updated) of the layer LA is 0.89. Since at this time, merely the layer outlier 0.89 of the layer L4 is less than the layer outlier threshold 0.9, the candidate layer selection module 112 may select the candidate layer as the layer LA. In other words, at this time, the candidate layer selection module 112 may dynamically determine the quantity K of the candidate layers to be 1. Then, the layer pruning module 113 may prune the layer LA from the model to obtain the pruned model.

It is worth mentioning that the device 100 may continue to execute the process shown in FIG. 3 until the layer outliers of all layers are greater than or equal to the layer outlier threshold.

It is worth mentioning that the device 100 may consider the quantity N of the layers to be pruned to continuously execute the process shown in FIG. 3. In other words, if the layer outliers of the N layers are greater than or equal to the layer outlier threshold, then the device 100 may stop executing the process shown in FIG. 3.

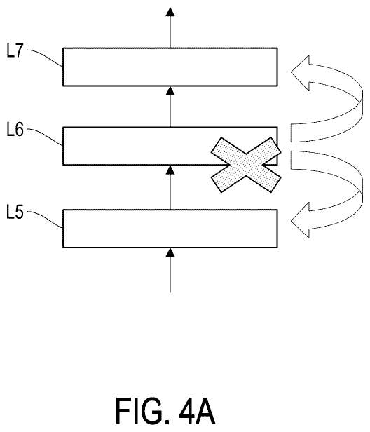

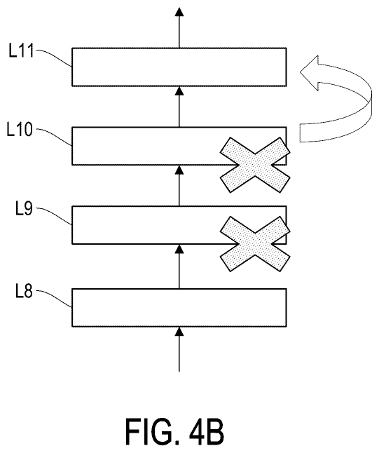

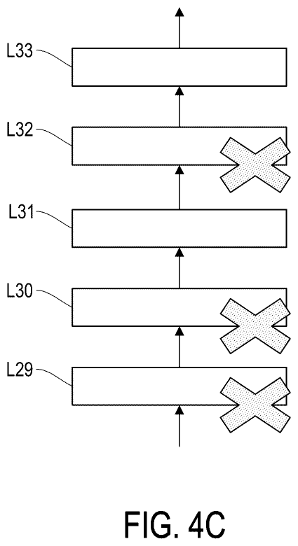

FIG. 4A, FIG. 4B, and FIG. 4C are implementation examples of Step S24 shown in FIG. 2. It should be noted here that the meaning of Step S24 in FIG. 2 is that the device 100 may fuse the pruned candidate layer back into the model instead of directly discarding the candidate layer. In this embodiment, the plurality of layers may include a neighboring layer adjacent to the candidate layer.

Referring to FIG. 4A first, in an embodiment, the layer fusion module 114 may use the matrix of the candidate layer and the matrix of the neighboring layer to obtain the fused model. It is assumed that the candidate layer is a layer L6. In other words, the quantity K of the candidate layers is 1, and the neighboring layers of the layer L6 (that is, a layer L5 and a layer L7) are not pruned candidate layers. The layer fusion module 114 may fuse the layer L6 to the layer L5, or the layer fusion module 114 may fuse the layer L6 to the layer L7, but the disclosure is not limited thereto. The following will continue the explanation with the layer fusion module 114 “fusing the layer L6 to the layer L7”. It is assumed that the layer L7 includes a matrix

$$W 7 = [ \begin{matrix}1.4 & 0.1 & - 0.3 & - 0.2 \\ - 0.9 & 1.7 & 0.6 & 1.1 \\ 1.8 & - 0.6 & 0.0 & - 1.3\end{matrix} ] ,$$

and assumed that the layer L6 includes a matrix

$$W 6 = [ \begin{matrix}0. & - 0.1 & - 0.6 & - 0.3 \\ - 1.3 & - 0.2 & 1.2 & 0. \\ 0.1 & 0.9 & 0.6 & 0.9\end{matrix} ] ,$$

The layer fusion module 114 may calculate a difference matrix W_{diff} between the matrix W6 and the matrix W7 (the matrix W6 is subtracted by the matrix W7), and the difference matrix

$${W}_{diff} = [ \begin{matrix}- 1.4 & - 0.2 & - 0.3 & - 0.1 \\ - 0.4 & - 1.9 & 0.6 & - 1.1 \\ 1.9 & 1.5 & 0.6 & 2.2\end{matrix} ]$$

is calculated. Then, the layer fusion module 114 may take the absolute value of the difference matrix W_{diff}, and then set the smallest a % and the largest b % elements to 0 to remove noise. Then, the layer fusion module 114 may calculate the updated matrix W7′=W7+α×W_{diff} based on the weight α. For example, the layer fusion module 114 may set a to 20, b to 10, and a to 0.1. Based on the above, the layer fusion module 114 may calculate

$$matrix = [ \begin{matrix}- 1.4 & 0 & - 0.3 & 0 \\ - 0.4 & - 1.9 & 0.6 & - 1.1 \\ - 1.9 & 1.5 & 0.6 & 0\end{matrix} ]$$

after removing the noise from the difference matrix W_{diff}.

It is worth mentioning that although the embodiment is described with the difference matrix between the matrix W6 and the matrix W7, the disclosure is not limited thereto. In other embodiments, the layer fusion module 114 may use the average or weighted average between the matrix W6 and the matrix W7 to execute Step S24 shown in FIG. 2.

Please continue to refer to FIG. 4B. It is assumed that the candidate layers are consecutive layer L9 and layer L10. In other words, the quantity K of the candidate layers is 2, and the neighboring layers (that is, a layer L8 and a layer L11) are not pruned candidate layers.

In an embodiment, the layer fusion module 114 may fuse the layer L9 and the layer L10 “together” to the layer L11 in a manner similar to FIG. 4A. In detail, it is assumed that a matrix W9 is included in the layer L9, a matrix W10 is included in the layer L10, and a matrix W11 is included in the layer L11. The layer fusion module 114 may calculate a difference matrix W_{diff_1} between the matrix W9 and the matrix W11 (the matrix W9 is subtracted by the matrix W11), and the layer fusion module 114 may calculate a difference matrix W_{diff_2} between the matrix W10 and the matrix W11 (the matrix W10 is subtracted by the matrix W11). Then, the layer fusion module 114 may calculate the updated matrix W11′=W11+α×(W_{diff_1}+W_{diff_2}) based on the weight α.

In another embodiment, the layer fusion module 114 may fuse the layer L9 and the layer L10 to the layer L11 “sequentially one by one” in a manner similar to FIG. 4A. In detail, the layer fusion module 114 may fuse “sequentially one by one” according to the size of the layer outliers of the layer L9 and the layer L10. Alternatively, the layer fusion module 114 may fuse “sequentially one by one” according to the layer number. For example, the layer fusion module 114 may first fuse the layer L9 to the layer L10, and then fuse the layer L10 to the layer L11. Alternatively, the layer fusion module 114 may first fuse the layer L10 to the layer L11, and then fuse the layer L9 to the layer L11.

In another embodiment, when K is greater than or equal to 2, the layer fusion module 114 may use the neighboring layer to select the layer discarded from fusion from the candidate layer. In detail, since the next layer (the layer L10) of the layer L9 is pruned, the layer fusion module 114 may select the layer discarded from fusion as the layer L9. In other words, the layer fusion module 114 may merely fuse the layer L10 to the layer L11.

Please continue to refer to FIG. 4C. It is assumed that the candidate layers are a layer L32, a layer L30, and a layer L29, assumed that the layer outlier of the layer L30 is less than the layer outlier of the layer L32, and assumed that the layer outlier of the layer L32 is less than the layer outlier of the layer L29.

In an embodiment, the layer fusion module 114 may fuse “sequentially one by one” in a manner similar to FIG. 4A. In detail, the layer fusion module 114 may fuse the layer L30 to the next layer (the layer L31). Then, the layer fusion module 114 may fuse the layer L32 to the next layer (the layer L33). Then, the layer fusion module 114 may fuse the layer L29 to the next layer. It should be noted that since the next layer (the layer L30) of the layer L29 is pruned, the layer fusion module 114 may fuse the layer L29 to the layer L31.

In another embodiment, since the next layer (the layer L30) of the layer L29 is pruned, the layer fusion module 114 may select the layer discarded from fusion as the layer L29. Then, the layer fusion module 114 may fuse the layer L30 to the next layer (the layer L31), and fuse the layer L32 to the next layer (the layer L33).

In another embodiment, the layer fusion module 114 may fuse the layer L30 and the layer L29 “together” to the next layer (the layer L31) of the layer L30 based on a method similar to FIG. 4A. Then, the layer fusion module 114 may fuse the layer L32 to the next layer (the layer L33).

It is worth mentioning that in the method for pruning the model of the disclosure, the sequence of some steps is not limited, and the sequence may also be reversed.

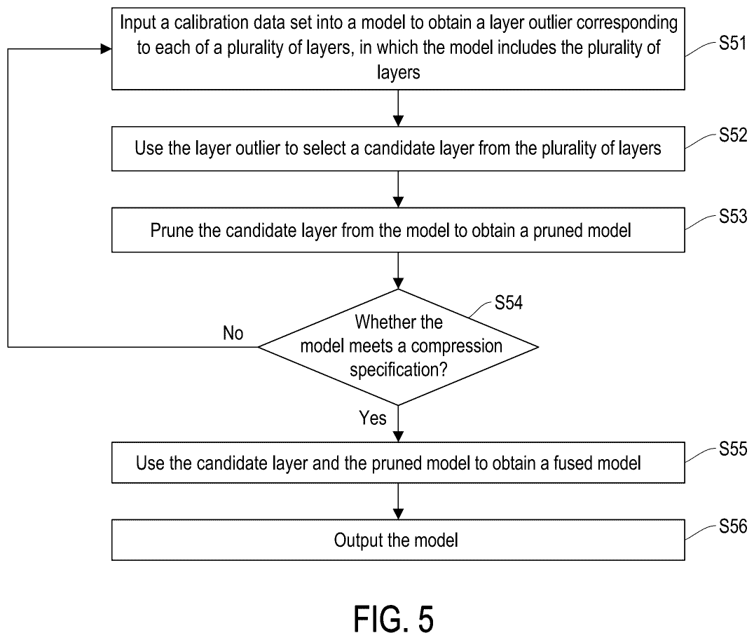

FIG. 5 is a flowchart of the method for pruning the model according to another embodiment of the disclosure, in which the method may be implemented by the device 100 shown in FIG. 1. Please refer to FIG. 1, FIG. 2, and FIG. 5 at the same time. The mere difference between FIG. 5 and FIG. 2 is that in the embodiment of FIG. 5, after the device 100 prunes from the model (Step S53), the device 100 first determine whether the model meets the compression specification (Step S54). Then, after the device 100 determines that the model meets the compression specification, fusion is performed (Step S55).

In summary, the device and the method for pruning the model of the disclosure can obtain the layer outlier of each layer in the model, use the layer outlier to select the candidate layer, and prune the candidate layer from the model. In particular, the disclosure can re-fuse the pruned layer back into the model. Based on the above, the disclosure can effectively reduce the size of the model while retaining more of the original capabilities of the model to avoid performance loss of the model. The disclosure can meet the demand for high-efficiency operation in a resource-limited environment, and the disclosure can be used in large language models.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A device for pruning a model, comprising:
a storage medium storing a plurality of modules; and
a processor coupled to the storage medium and accessing and executing the plurality of modules, wherein the plurality of modules comprise:
a layer outlier obtaining module inputting a calibration data set into the model to obtain a layer outlier corresponding to each of a plurality of layers, wherein the model comprises the plurality of layers;
a candidate layer selection module using the layer outlier to select a candidate layer from the plurality of layers;
a layer pruning module pruning the candidate layer from the model to obtain a pruned model;
a layer fusion module using the candidate layer and the pruned model to obtain a fused model; and
a compression specification module determining whether the model meets a compression specification.

2. The device as claimed in claim 1, wherein each of the plurality of layers comprises a matrix, wherein
the layer outlier obtaining module uses an absolute value of the matrix and a normalized calibration data set to obtain a target matrix corresponding to the matrix,
the layer outlier obtaining module obtains an outlier rate corresponding to the target matrix, and
the layer outlier obtaining module uses the outlier rate to obtain the layer outlier.

3. The device as claimed in claim 2, wherein the target matrix comprises elements, and
the layer outlier obtaining module uses a quantity of the elements, a mean of the elements, and a standard deviation of the elements to obtain the outlier rate.

4. The device as claimed in claim 1, further comprising an input-output device coupled to the processor, wherein
the compression specification module receives the compression specification through the input-output device.

5. The device as claimed in claim 1, wherein the plurality of layers comprise a layer to be pruned, and the compression specification comprises a quantity of the layer to be pruned.

6. The device as claimed in claim 5, wherein the quantity of the layer to be pruned is N, and
the candidate layer selection module sets a quantity of the candidate layer to K, and K is less than or equal to N.

7. The device as claimed in claim 1, wherein the compression specification comprises an accuracy threshold, and
the compression specification module uses a target evaluation data set to determine whether the pruned model meets the accuracy threshold.

8. The device as claimed in claim 1, wherein the compression specification comprises an inference speed threshold.

9. The device as claimed in claim 1, wherein the compression specification comprises a hardware limitation threshold.

10. The device as claimed in claim 1, wherein
the candidate layer selection module uses the layer outlier and a layer outlier threshold to select the candidate layer from the plurality of layers.

11. The device as claimed in claim 1, wherein each of the plurality of layers comprises a matrix, the plurality of layers comprise a neighboring layer adjacent to the candidate layer, and
the layer fusion module uses the matrix of the candidate layer and the matrix of the neighboring layer to obtain the fused model.

12. The device as claimed in claim 1, wherein a quantity of the candidate layer is K, the plurality of layers comprise a neighboring layer adjacent to the candidate layer, and
in response to K being greater than or equal to 2, the layer fusion module uses the neighboring layer to select a layer discarded from fusion from the candidate layers.

13. A method for pruning a model, suitable for a device comprising a storage medium and a processor, wherein the storage medium stores a plurality of modules, the processor is coupled to the storage medium and accesses and executes the plurality of modules, the plurality of modules comprise a layer outlier obtaining module, a candidate layer selection module, a layer pruning module, a layer fusion module, and a compression specification module, and the method comprises:
inputting, by the layer outlier obtaining module, a calibration data set into the model to obtain a layer outlier corresponding to each of a plurality of layers, wherein the model comprises the plurality of layers;
using, by the candidate layer selection module, the layer outlier to select a candidate layer from the plurality of layers;
pruning, by the layer pruning module, the candidate layer from the model to obtain a pruned model;
using, by the layer fusion module, the candidate layer and the pruned model to obtain a fused model; and
determining, by the compression specification module, whether the model meets a compression specification.

14. The method as claimed in claim 13, wherein each of the plurality of layers comprises a matrix, and an operation of inputting, by the layer outlier obtaining module, the calibration data set into the model to obtain the layer outlier corresponding to each of the plurality of layers comprises:
using, by the layer outlier obtaining module, an absolute value of the matrix and a normalized calibration data set to obtain a target matrix corresponding to the matrix;
obtaining, by the layer outlier obtaining module, an outlier rate corresponding to the target matrix; and
using, by the layer outlier obtaining module, the outlier rate to obtain the layer outlier.

15. The method as claimed in claim 14, wherein the target matrix comprises elements, and
an operation of obtaining, by the layer outlier obtaining module, the outlier rate corresponding to the target matrix comprises:
using, by the layer outlier obtaining module, a quantity of the elements, a mean of the elements, and a standard deviation of the elements to obtain the outlier rate.

16. The method as claimed in claim 13, wherein the device further comprises an input-output device coupled to the processor, and the method further comprises:
receiving, by the compression specification module, the compression specification through the input-output device.

17. The method as claimed in claim 13, wherein the plurality of layers comprise a layer to be pruned, and the compression specification comprises a quantity of the layer to be pruned.

18. The method as claimed in claim 17, wherein the quantity of the layer to be pruned is N, and an operation of using, by the candidate layer selection module, the layer outlier to select the candidate layer from the plurality of layers comprises:
setting, by the candidate layer selection module, a quantity of the candidate layer to K, wherein K is less than or equal to N.

19. The method as claimed in claim 13, wherein the compression specification comprises an accuracy threshold, and an operation of determining, by the compression specification module, whether the model meets the compression specification comprises:
using, by the compression specification module, a target evaluation data set to determine whether the pruned model meets the accuracy threshold.

20. The method as claimed in claim 13, wherein the compression specification comprises an inference speed threshold.

21. The method as claimed in claim 13, wherein the compression specification comprises a hardware limitation threshold.

22. The method as claimed in claim 13, wherein an operation of using, by the candidate layer selection module, the layer outlier to select the candidate layer from the plurality of layers comprises:
using, by the candidate layer selection module, the layer outlier and a layer outlier threshold to select the candidate layer from the plurality of layers.

23. The method as claimed in claim 13, wherein each of the plurality of layers comprises a matrix, the plurality of layers comprise a neighboring layer adjacent to the candidate layer, and an operation of using, by the layer fusion module, the candidate layer and the pruned model to obtain the fused model comprises:
using, by the layer fusion module, the matrix of the candidate layer and the matrix of the neighboring layer to obtain the fused model.

24. The method as claimed in claim 13, wherein a quantity of the candidate layer is K, the plurality of layers comprise a neighboring layer adjacent to the candidate layer, and an operation of using, by the layer fusion module, the candidate layer and the pruned model to obtain the fused model comprises:
in response to K being greater than or equal to 2, the layer fusion module uses the neighboring layer to select a layer discarded from fusion from the candidate layers.
